(19) United States
(12) Patent Application Publication
(10) Pub. No.: US 2026/0371224 A1
(43) Pub. Date: Nov. 19, 2026

(54) WIRELESS DEVICE, NETWORK NODE AND METHOD FOR COMMUNICATION

(71) Applicant: Telefonaktiebolaget LM Ericsson (publ), Stockholm (SE)

(72) Inventors: Lian ARAUJO, Stockholm (SE); Mattias BERGSTRÖM, Singapore (SG); Sladana JOSILO, Solna (SE)

(21) Appl. No.: 19/125,140

(22) PCT Filed: Nov. 2, 2023
(86) PCT No.: PCT/SE2023/051115

§ 371 Date: Apr. 28, 2025

Related U.S. Application Data
(60) Provisional application No. 63/421,816, filed on Nov. 2, 2022.

(51) Int. Cl. H04W 48/02; H04W 48/12

(52) U.S. Cl. CPC H04W 48/02; H04W 48/12

(57) ABSTRACT

A method, network node and wireless device (WD) for handling cell barring for multiple features are disclosed. According to one aspect, a method in a WD includes receiving a set of indications from the network node in which each indication is associated with a respective feature relevant for determining whether the WD is allowed to access or camp on a cell served by the network node. Each indication indicates whether or not said respective feature is supported in the cell. The method also includes determining whether the WD is barred from the cell based at least in part on whether the WD supports a feature indicated by an indication in the set of indications as supported in the cell.

### TECHNICAL FIELD

The present disclosure relates to wireless communications between a wireless device and a network node, and in particular, to handling cell barring for multiple features.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### MIB Acquisition and Cell Barring

In NR, the Master Information Block (MIB) on the physical broadcast channel (PBCH) provides the WD with parameters (e.g., control resource set (CORESET) #0 configuration) for monitoring of physical downlink control channel (PDCCH) for scheduling the physical downlink shared channel (PDSCH) that carries the System Information Block 1 (SIB1). The MIB also includes information on whether a cell is barred or not:

MIB
-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
-- TAG-MIB-STOP
-- ASN1STOP

MIB field descriptions

```
  cellBarred
  Value barred means that the cell is barred, as defined in TS 38.304 [20].
  This
field is ignored by IAB-MT. This field is ignored for connectivity to NTN.
```

Barring is used for multiple reasons relating to deployment (e.g., the cell is not used for initial access) and maintenance. For features added in later releases, e.g., non-terrestrial network (NTN) and integrated access and backhaul (IAB), another barring method was adopted. This method enables, for example, NTN WDs to access the cell but bar WDs that do not support NTN. The cell barring method for NTN is described below. The method adopted for other features, e.g., a WD with reduced capabilities (RedCap) as specified in 3GPP standards such as in, for example, clause 4.2.21.1 in 3GPP Technical Standard (TS) 38.306 and Integrated Access and Backhaul (IAB) contain small differences but are generally similar.

### Cell Barring for NTN

In order to have a different cell barring method than the one in SIB, 3GPP TS 38.331 describes in MIB that for NTN, the WD should ignore the field provided in MIB.

MIB field descriptions

```
  cellBarred
  Value barred means that the cell is barred, as defined in TS 38.304 [20].
  This
field is ignored by IAB-MT. This field is ignored for connectivity to NTN.
```

The WD should instead derive whether the cell is barred or not through a dedicated field for NTN:

```
  SIB1 message
  -- ASN1START
  -- TAG-SIB1-START
  SIB1 ::= SEQUENCE {
```

| | |
|---|---|
| cellSelectionInfo | SEQUENCE { |
| q-RxLevMin | Q-RxLevMin, |
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| q-QualMinOffset | INTEGER (1..8) |

OPTIONAL -- Need S

| | |
|---|---|
| } | OPTIONAL, -- |

Cond Standalone

| | |
|---|---|
| cellAccessRelatedInfo | CellAccessRelatedInfo, |
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-Emergency Support | ENUMERATED {true} |

OPTIONAL, -- Need R

| | |
|---|---|
| eCallOverIMS-Support | ENUMERATED {true} |

OPTIONAL, -- Need R

| | |
|---|---|
| WD-TimersAndConstants | WD-TimersAndConstants |

OPTIONAL, -- Need R

| | |
|---|---|
| uac-BarringInfo | SEQUENCE { |
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1- |

SelectionAssistanceInfo,

| | |
|---|---|
| individualPLMNList | SEQUENCE (SIZE (2..maxPLMN)) OF |

UAC-AccessCategory1-SelectionAssistanceInfo

| | |
|---|---|
| } | OPTIONAL |

-- Need S

| | |
|---|---|
| } | OPTIONAL, -- |

Need R

| | |
|---|---|
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

```
OPTIONAL
  }
  #####ommitted irrelevant parts######
```

| | |
|---|---|
| SIB1-v1700-IEs ::= | SEQUENCE { |
| hsdn-Cell-r17 | ENUMERATED {true} |

OPTIONAL, -- Need R

| | |
|---|---|
| uac-BarringInfo-v1700 | SEQUENCE { |
| uac-BarringInfoSetList-v1700 | UAC-BarringInfoSetList-v1700 |

| | |
|---|---|
| } | OPTIONAL, -- |

Cond MINT

| | |
|---|---|
| sdt-ConfigCommon-r17 | SDT-ConfigCommonSIB-r17 |

OPTIONAL, -- Need R

| | |
|---|---|
| redCap-ConfigCommon-r17 | RedCap-ConfigCommonSIB-r17 |

OPTIONAL, -- Need R

| | |
|---|---|
| featurePriorities-r17 | SEQUENCE { |
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

OPTIONAL -- Need R

| | |
|---|---|
| } | OPTIONAL, -- |

Need R

| | |
|---|---|
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | |
|---|---|
| eDRX-AllowedIdle-r17 | ENUMERATED {true} |

OPTIONAL, -- Need R

| | |
|---|---|
| eDRX-AllowedInactive-r17 | ENUMERATED {true} |

OPTIONAL, -- Cond EDRX-RC

| | |
|---|---|
| intraFreqReselectionRedCap-r17 | ENUMERATED {allowed, notAllowed} |

OPTIONAL, -- Need S

| | |
|---|---|
| cellBarredNTN-r17 | ENUMERATED {barred, notBarred} |

OPTIONAL, -- Need S

| | |
|---|---|
| nonCriticalExtension | SEQUENCE { } |

OPTIONAL
}

SIB1 field descriptions

```
  cellBarredNTN
  Value barred means that the cell is barred for connectivity to NTN, as
defined in TS 38.304 [20]. Value notBarred means that the cell is allowed
for connectivity to NTN. If not present, the WD considers the cell is
not allowed for connectivity to NTN, as defined in TS 38.304 [20]. This
field is only applicable to NTN-capable WDs.
```

In LTE and NR, the WD considers a cell barred via a field indication in that cell's MIB. In some cases, when a feature is applied on a certain cell, it is required to bar from that cell WDs that do not support such feature (through MIB) and include a new field on another level to indicate whether the cell is barred or not for WDs that support the feature (e.g., through SIB). This method forces WDs that implement the feature to read MIB and additionally, e.g., read SIB to retrieve the information on whether the cell is actually barred for this WD. This may delay the initial access procedure. Furthermore, this also implies that different cell barring methods are applied for WDs depending on the supported features, which also increases complexity of the cell barring scheme.

### SUMMARY

Some embodiments advantageously provide methods, network nodes and wireless devices (WDs) for handling cell barring for multiple features.

Methods are disclosed to enable WDs supporting different features to retrieve cell barring information through MIB or other system information message.

Disclosed methods may make initial access faster since the WD does not need to read SIB to derive whether a cell is barred or not. Disclosed solutions are also forward compatible since, even if features are added in later releases of a radio access technology (RAT) that may impact cell access, the same framework may be used by multiple WDs and network implementations to bar WDs from a cell.

According to a first aspect, a wireless device, WD, configured to communicate with a network node is provided. The WD is configured to: receive a set of indications from the network node, each indication being associated with a respective feature relevant for determining whether the WD is allowed to access or camp on a cell served by the network node, each indication indicating whether or not said respective feature is supported in the cell; and determine whether the WD is barred from the cell based at least in part on whether the WD supports a feature indicated, by an indication in the set of indications, as supported in the cell.

According to the first aspect, in some embodiments, the WD being configured to determine whether the WD is barred from the cell includes the WD being configured to compare features supported by the WD to features indicated by the set of indications to be supported in the cell. In some embodiments, the set of indications may be one of: a bit string, each bit being associated with a respective feature relevant for determining whether the WD is allowed to access or camp on the cell served by the network node; and a set of fields, each field being associated with a respective feature relevant for determining whether or not the WD is allowed to access or camp on the cell served by the network node. In some embodiments, the WD being configured to determine whether the WD is barred from the cell includes the WD being configured to determine, for features supported by the WD, whether or not the indications associated with corresponding features in the set of indications indicate that these features are supported in the cell and determine that the WD is barred from the cell when a result of the determination for the features supported by the WD is that the WD is barred for each of the features that the WD supports. In some embodiments, the WD being configured to determine whether the WD is barred from the cell includes the WD being configured to determine, for features supported by the WD, whether or not the indications associated with corresponding features in the set of indications indicate that these features are supported in the cell and determine that the WD is barred from the cell when a result of the determination for the features supported by the WD is that the WD is barred for at least one of the features that the WD supports. In some embodiments, the WD being configured to determine whether the WD is barred from the cell includes the WD being configured to determine whether the WD is barred from the cell for a subset of the features that the WD supports. In some embodiments, the WD being configured to determine whether the WD is barred from the cell includes the WD being configured to determine, for features that the WD does not support, whether or not the indications associated with corresponding features in the set of indications indicate that these features are supported in the cell. In some of these embodiments, the WD is further configured to determine that the WD is barred from the cell when a result of the determination for features that the WD does not support is that the WD is barred for at least one of the features that the WD does not support. In other of these embodiments, when a result of the determination for features that the WD does not support is that the WD is not barred for any of said features that the WD does not support, the WD is further configured to determine, for features supported by the WD, whether or not the indications associated with corresponding features in said set of indications indicate that these features are supported in the cell and determine that the WD is barred from the cell when a result of the determination for the features supported by the WD is that the WD is barred for at least one of the features that the WD supports. In yet another of these embodiments, when a result of the determination for features that the WD does not support is that the WD is not barred for any of the features that the WD does not support, the WD is further configured to determine, for features supported by the WD, whether or not the indications associated with corresponding features in the set of indications indicate that these features are supported in the cell and determine that the WD is barred from the cell when a result of the determination for the features supported by the WD is that the WD is barred for each of the features that the WD supports. In some embodiments, the set of indications may be a bit string and each indication may be a bit in the bit string. In other embodiments, the set of indications may be a set of fields and each indication may be a field in the set of fields.

According to a second aspect, a method performed by a wireless device, WD, for communicating with a network node is provided. The method includes receiving a set of indications from the network node, each indication being associated with a respective feature relevant for determining whether the WD is allowed to access or camp on a cell served by the network node, each indication indicating whether or not said respective feature is supported in the cell. The method includes determining whether the WD is barred from the cell based at least in part on whether the WD supports a feature indicated by an indication in the set of indications as supported in the cell.

According to the second aspect, in some embodiments, determining whether the WD is barred from the cell includes comparing features supported by the WD to features indicated by the set of indications to be supported in the cell. In some embodiments, the set of indications may be one of: a bit string, each bit being associated with a respective feature relevant for determining whether the WD is allowed to access or camp on the cell served by the network node; and a set of fields, each field being associated with a respective feature relevant for determining whether or not the WD is allowed to access or camp on the cell served by the network node. In some embodiments, determining whether the WD is barred from the cell includes determining, for features supported by the WD, whether or not the indications associated with corresponding features in the set of indications indicate that these features are supported in the cell and determining that the WD is barred from the cell when a result of the determination for the features supported by the WD is that the WD is barred for each of the features that the WD supports. In some embodiments, determining whether the WD is barred from the cell includes determining, for features supported by the WD, whether or not the indications associated with corresponding features in the set of indications indicate that these features are supported in the cell and determining that the WD is barred from the cell when a result of the determination for the features supported by the WD is that the WD is barred for at least one of the features that the WD supports. In some embodiments, determining whether the WD is barred from the cell includes determining whether the WD is barred from the cell for a subset of the features that the WD supports. In some embodiments, determining whether the WD is barred from the cell includes determining, for features that the WD does not support, whether or not the indications associated with corresponding features in the set of indications indicate that these features are supported in the cell. In some of these embodiments, the method includes determining that the WD is barred from the cell when a result of the determination for features that the WD does not support is that the WD is barred for at least one of the features that the WD does not support. In other of these embodiments, when a result of the determination for features that the WD does not support is that the WD is not barred for any of said features that the WD does not support, the method further includes determining, for features supported by the WD, whether or not the indications associated with corresponding features in said set of indications indicate that these features are supported in the cell and determining that the WD is barred from the cell when a result of the determination for the features supported by the WD is that the WD is barred for at least one of the features that the WD supports. In yet another of these embodiments, when a result of the determination for features that the WD does not support is that the WD is not barred for any of the features that the WD does not support, the method further includes determining, for features supported by the WD, whether or not the indications associated with corresponding features in the set of indications indicate that these features are supported in the cell and determining that the WD is barred from the cell when a result of the determination for the features supported by the WD is that the WD is barred for each of the features that the WD supports. In some embodiments, the set of indications may be a bit string and each indication may be a bit in the bit string. In other embodiments, the set of indications may be a set of fields and each indication may be a field in the set of fields.

According to a third aspect, a network node configured to communicate with a WD is provided. The network node is configured to: determine a set of indications, each indication being associated with a respective feature relevant for determining whether the WD is allowed to access or camp on a cell served by the network node, each indication indicating whether or not the respective feature is supported in the cell; and transmit the set of indications to the WD.

According to a fourth aspect, a method performed by a network node for communicating with a WD is provided. The method includes determining a set of indications, each indication being associated with a respective feature relevant for determining whether the WD is allowed to access or camp on a cell served by the network node, each indication indicating whether or not the respective feature is supported in the cell; and transmitting the set of indications to the WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for handling cell barring for multiple features;

FIG. 8 is a flowchart of an example process in a wireless device for handling cell barring for multiple features;

FIG. 9 is a flowchart of another example process in a wireless device for handling cell barring for multiple features; and

FIG. 10 is a flowchart of another example process in a network node for handling cell barring for multiple features.

### DETAILED DESCRIPTION

Before describing in detail example embodiments, it is noted that the embodiments reside primarily in combinations of apparatus components and processing steps related to handling cell barring for multiple features. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this may not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein may be interpreted as having a meaning that is consistent with their meaning in the context of this specification and the relevant art and will not be interpreted in an idealized or overly formal sense unless expressly so defined herein.

As used herein, the term “access” to a cell or cell feature includes initial access and continued access, such as when the WD is camped on the cell.

Some embodiments provide handling cell barring for multiple features.

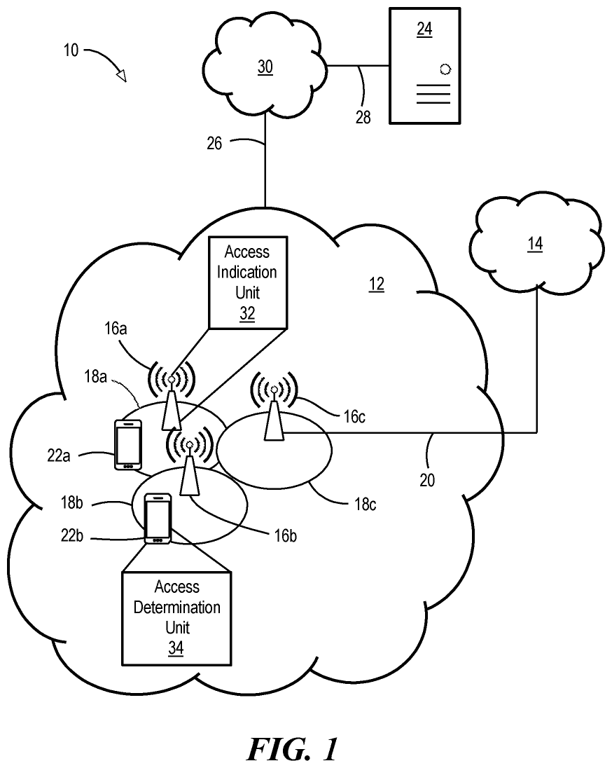

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an access indication unit 32 which may be configured to determine whether the WD is to be barred from access to a cell of the network node for each of a plurality of cell-supported features, the determination being based at least in part on a comparison of WD-supported features with the cell-supported features. The access indication unit 32 may be configured to determine a set of indications, each indication being associated with a respective feature relevant for determining whether the WD is allowed to access or camp on a cell served by the network node, each indication indicating whether or not the respective feature is supported in the cell. A wireless device 22 is configured to include an access determination unit 34 which may be configured to determine whether the WD is barred from access to the cell for each cell-supported feature based at least in part on the set of indications and on WD-supported features of the cell-supported features. The access determination unit 34 may be configured to determine whether the WD is barred from the cell based at least in part on whether the WD supports a feature indicated by an indication in the set of indications as supported in the cell.

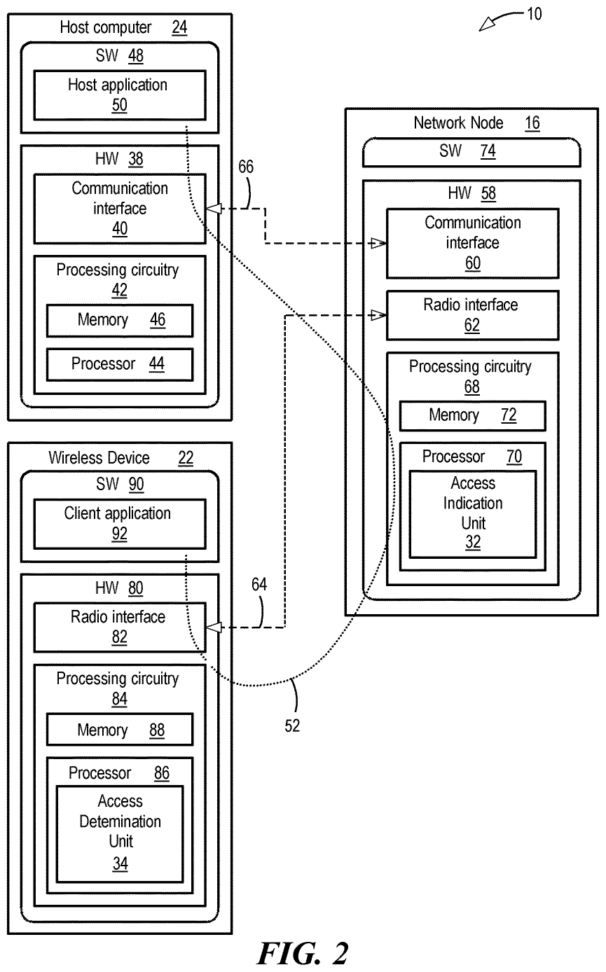

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an access indication unit 32 which is configured to determine whether the WD is to be barred from access to a cell of the network node for each of a plurality of cell-supported features, the determination being based at least in part on a comparison of WD-supported features with the cell-supported features.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an access determination unit 34 which is configured to determine whether the WD is barred from access to the cell for each cell-supported feature based at least in part on the set of indications and on WD-supported features of the cell-supported features.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as access indication unit 32, and access determination unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

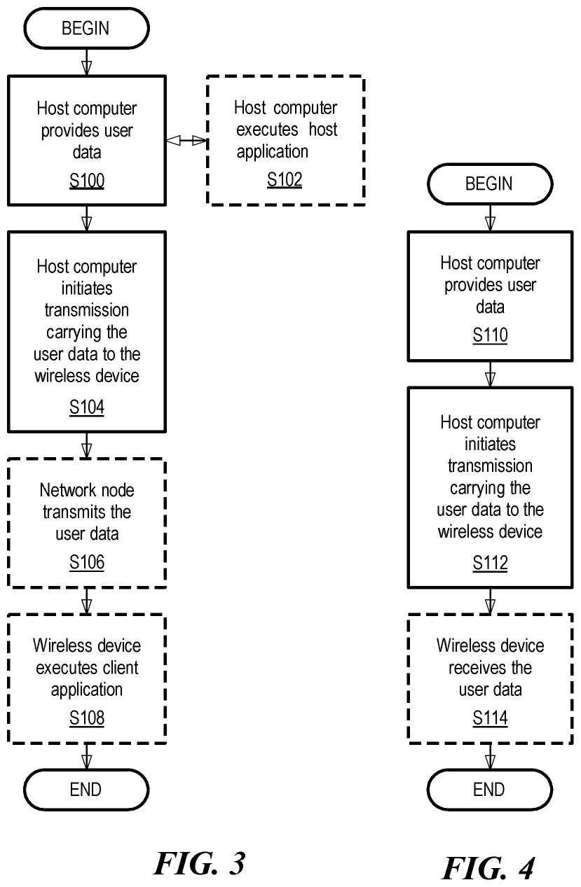

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

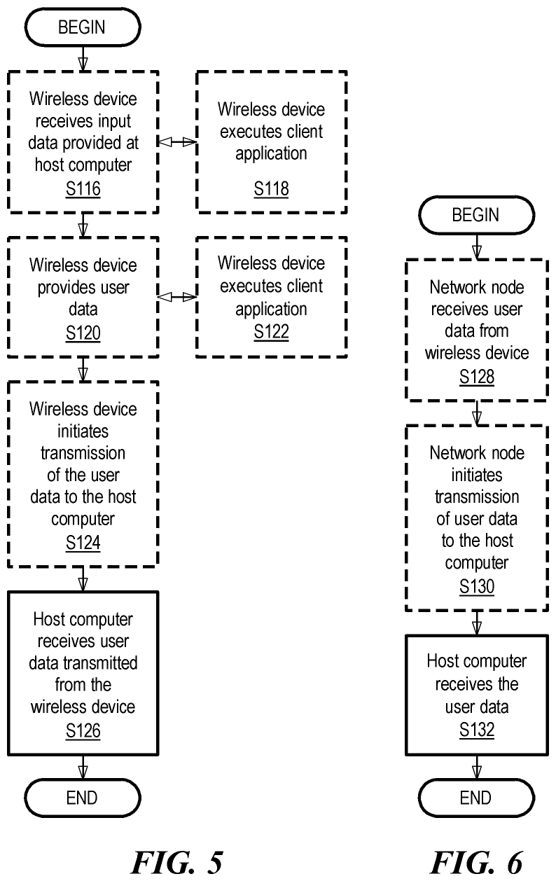

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 7 is a flowchart of an example process in a network node 16 for handling cell barring for multiple features. One or more blocks described herein may be performed by one or more elements of network node 16 such as by one or more of processing circuitry 68 (including the access indication unit 32), processor 70, radio interface 62 and/or communication interface 60. Network node 16 is configured to determine whether the WD 22 is to be barred from access to a cell of the network node 16 for each of a plurality of cell-supported features, the determination being based at least in part on a comparison of WD-supported features with the cell-supported features (Block S134). The process also includes transmitting a set of indications to the WD 22, the set of indications indicating whether the WD 22 is to be barred from access to the cell for each of the cell-supported features (Block S136).

In some embodiments, determining whether the WD 22 is to be barred from access to the cell for each feature includes performing an OR operation of a bit string of the set of indications with a bit string of the WD-supported features. In some embodiments, determining whether the WD 22 is to be barred from access to the cell for each feature includes performing an AND operation of a bit string of the set of indications with a bit string of the WD-supported features.

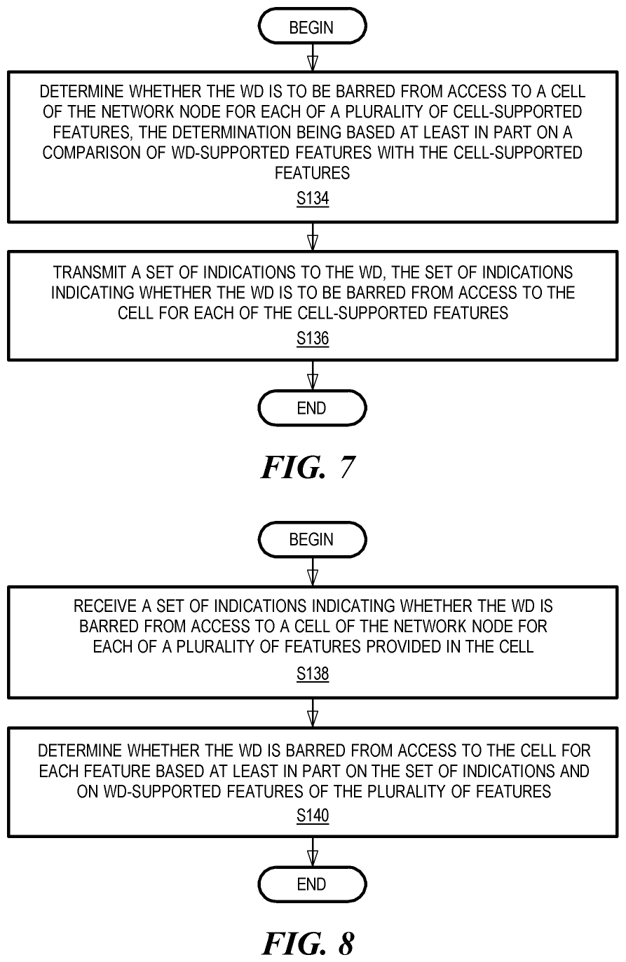

FIG. 8 is a flowchart of an example process in a wireless device 22 according to some embodiments of the present disclosure. One or more blocks described herein may be performed by one or more elements of wireless device 22 such as by one or more of processing circuitry 84 (including the access determination unit 34), processor 86, radio interface 82 and/or communication interface 60. Wireless device 22 is configured to receive a set of indications indicating whether the WD 22 is barred from access to a cell of the network node 16 for each of a plurality of features provided in the cell (Block S138). The process also includes determining whether the WD 22 is barred from access to the cell for each feature based at least in part on the set of indications and on WD-supported features of the plurality of features (Block S140).

In some embodiments, determining whether the WD 22 is barred from access to the cell for each cell-supported feature includes performing an OR operation of a bit string of the set of indications with a bit string of the WD-supported features. In some embodiments, the process also includes, when at least one bit of the set of indications indicates that the WD 22 is not barred from access to the cell for a WD-supported feature, concluding that access to the cell is not barred for the feature. In some embodiments, the method also includes, when all bits of the set of indications indicate that the WD 22 is barred for each WD-supported feature, concluding that access to the cell is barred for each WD-supported feature. In some embodiments, determining whether the WD 22 is barred from access to the cell for each cell-supported feature includes performing an AND operation of a bit string of the set of indications with a bit string of the WD-supported features. In some embodiments, the process also includes when at least one bit of the set of indications indicates that the WD 22 is barred from access to the cell for a feature that the WD 22 supports, concluding that access to the cell is barred for the feature.

In some embodiments the process also includes, when all bits of the set of indications indicate that the WD 22 is not barred for each WD-supported feature, concluding that access to the cell is not barred for each WD-supported feature. In some embodiments, determining whether the WD 22 is barred from access to the cell for a feature, includes: performing a first AND operation on bits associated with features that are not WD-supported to determine when access to the cell is barred because the cell uses a feature that is not WD-supported; and when performing the first AND operation indicates that the cell does not use a feature that is not WD-supported, performing a second AND operation on bits associated with features that are WD-supported to determine when access to the cell is barred for a feature that is WD-supported. In some embodiments, determining whether the WD 22 is barred from access to the cell for a feature, includes: performing an AND operation on bits associated with features that are not WD-supported to determine when access to the cell is barred because the cell uses a feature that is not WD-supported; and when performing the AND operation indicates that the cell does not use a feature that is not WD-supported, performing an OR operation on bits associated with features that are WD-supported to determine when access to the cell is barred for a feature that is WD-supported.

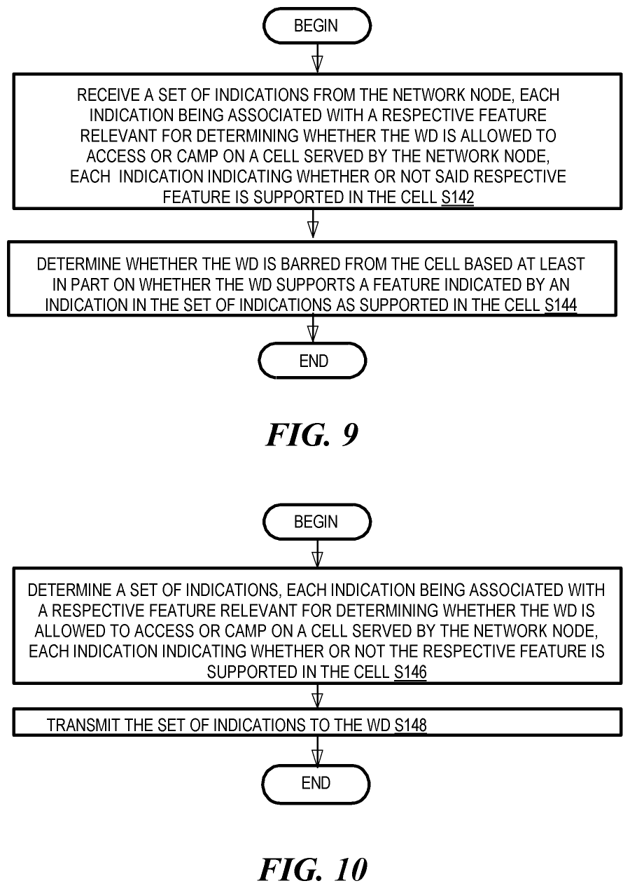

FIG. 9 is a flowchart of an example process in a wireless device 22 according to some embodiments of the present disclosure. One or more blocks described herein may be performed by one or more elements of wireless device 22 such as by one or more of processing circuitry 84 (including the access determination unit 34), processor 86, radio interface 82 and/or communication interface 60. Wireless device 22 is configured to receive a set of indications from a network node 16, each indication being associated with a respective feature relevant for determining whether the WD 22 is allowed to access or camp on a cell 18 served by the network node 16, each indication indicating whether or not said respective feature is supported in the cell 18 (Block S142). The process includes determining whether the WD 22 is barred from the cell 18 based at least in part on whether the WD 22 supports a feature indicated by an indication in the set of indications as supported in the cell 18 (Block S144).

In some embodiments, determining whether the WD 22 is barred from the cell 18 includes comparing features supported by the WD 22 to features indicated by the set of indications to be supported in the cell 18. In some embodiments, the set of indications may be one of: a bit string, each bit being associated with a respective feature relevant for determining whether the WD 22 is allowed to access or camp on the cell 18 served by the network node 16; and a set of fields, each field being associated with a respective feature relevant for determining whether or not the WD 22 is allowed to access or camp on the cell 18 served by the network node 16. In some embodiments, determining whether the WD 22 is barred from the cell 18 includes determining, for features supported by the WD 22, whether or not the indications associated with corresponding features in the set of indications indicate that these features are supported in the cell 18 and determining that the WD 22 is barred from the cell 18 when a result of the determination for the features supported by the WD 22 is that the WD 22 is barred for each of the features that the WD 22 supports. In some embodiments, determining whether the WD 22 is barred from the cell 18 includes determining, for features supported by the WD 22, whether or not the indications associated with corresponding features in the set of indications indicate that these features are supported in the cell 18 and determining that the WD 22 is barred from the cell 18 when a result of the determination for the features supported by the WD 22 is that the WD 22 is barred for at least one of the features that the WD 22 supports. In some embodiments, determining whether the WD 22 is barred from the cell 18 includes determining whether the WD 22 is barred from the cell 18 for a subset of the features that the WD 22 supports.

In some embodiments, determining whether the WD 22 is barred from the cell 18 includes determining, for features that the WD 22 does not support, whether or not the indications associated with corresponding features in the set of indications indicate that these features are supported in the cell 18. In some of these embodiments, the method includes determining that the WD 22 is barred from the cell 18 when a result of the determination for features that the WD 22 does not support is that the WD 22 is barred for at least one of the features that the WD 22 does not support. In other of these embodiments the method further includes, when a result of the determination for features that the WD 22 does not support is that the WD 22 is not barred for any of said features that the WD 22 does not support, determining, for features supported by the WD 22, whether or not the indications associated with corresponding features in said set of indications indicate that these features are supported in the cell 18 and determining that the WD 22 is barred from the cell 18 when a result of the determination for the features supported by the WD 22 is that the WD 22 is barred for at least one of the features that the WD 22 supports. In yet another of these embodiments the method further includes, when a result of the determination for features that the WD 22 does not support is that the WD 22 is not barred for any of the features that the WD 22 does not support, determining, for features supported by the WD 22, whether or not the indications associated with corresponding features in the set of indications indicate that these features are supported in the cell 18 and determining that the WD 22 is barred from the cell when a result of the determination for the features supported by the WD 22 is that the WD 22 is barred for each of the features that the WD 22 supports.

In some embodiments, the set of indications may be a bit string and each indication may be a bit in the bit string. In other embodiments, the set of indications may be a set of fields and each indication may be a field in the set of fields.

In one example, where the received set of indications is implemented as a bit string, determining whether the WD 22 is barred from the cell includes comparing bits representing features that the WD 22 supports to bits associated with corresponding features in the received bit string. In some embodiments, determining whether the WD 22 is barred from the cell includes performing a logical OR operation between the results of the comparisons of bits of the received bit string and bits representing features supported by the WD 22 and determining that the WD 22 is barred from the cell when results of the logical OR operation indicate that the WD 22 is barred for each feature the WD 22 supports. In some embodiments, determining whether the WD 22 is barred from the cell includes performing a logical AND operation between the results of the comparisons of bits of the received bit string and bits representing features that the WD 22 supports and determining that the WD 22 is barred from the cell when at least one result of the logical AND operation indicates that the WD 22 is barred from the cell for a feature that the WD 22 supports. In some embodiments, determining whether the WD 22 is barred from the cell includes determining whether the WD 22 is barred from the cell for a subset of features that the WD 22 supports. In some embodiments, determining whether the WD 22 is barred from the cell includes performing a first logical AND operation between results of comparisons of bits representing features that the WD 22 does not support to bits associated with corresponding features in the received bit string. In some of these embodiments, the method includes determining that the WD 22 is barred from the cell when a result of the first logical AND operation is FALSE, i.e. when at least one feature not supported by the WD is indicated as supported by the cell in the received bit string. In other of these embodiments, the method includes, when the result of the first logical AND operation is TRUE, i.e. when none of the features not supported by the WD is indicated as supported by the cell in the received bit string, determining that the WD 22 is barred from the cell when a result of a second logical AND operation between results of comparisons of bits representing features that the WD 22 supports to bits associated with corresponding features in the received bit string is FALSE, i.e. when at least one feature supported by the WD is not indicated as supported by the cell in the received bit string. In yet another of these embodiments, the method includes, when a result of the first logical AND operation is TRUE, i.e. when none of the features not supported by the WD is indicated as supported by the cell in the received bit string, determining that the WD 22 is barred from the cell when a result of a logical OR operation between results of comparisons of bits representing features that the WD 22 supports to bits associated with corresponding features in the received bit string is FALSE, i.e. when no feature supported by the WD is indicated as supported by the cell in the received bit string. In some embodiments, the method includes receiving multiple bit strings and performing a comparison of each received bit string with at least one of bits representing features the WD 22 supports and bits representing features that the WD 22 does not support, each one of the multiple received bit strings representing a different set of features.

In this example, the WD being configured to determine whether the WD is barred from the cell includes the WD being configured to compare bits representing features that the WD supports to bits associated with corresponding features in the received bit string. In some embodiments, the WD being configured to determine whether the WD is barred from the cell includes the WD being configured to perform a logical OR operation between the results of the comparisons of bits of the received bit string and bits representing features supported by the WD and determine that the WD is barred from the cell when results of the logical OR operation indicate that the WD is barred for each feature the WD supports. In some embodiments, the WD being configured to determine whether the WD is barred from the cell includes the WD being configured to perform a logical AND operation between the results of the comparisons of bits of the received bit string and bits representing features that the WD supports and determine that the WD is barred from the cell when at least one result of the logical AND operation indicates that the WD is barred from the cell for a feature that the WD supports. In some embodiments, the WD being configured to determine whether the WD is barred from the cell includes the WD being configured to determine whether the WD is barred from the cell for a subset of features that the WD supports. In some embodiments, the WD being configured to determine whether the WD is barred from the cell includes the WD being configured to perform a first logical AND operation between results of comparisons of bits representing features that the WD does not support to bits associated with corresponding features in the received bit string. In some of these embodiments, the WD is configured to determine that the WD is barred from the cell when a result of the first logical AND operation is FALSE, i.e. when at least one feature not supported by the WD is indicated as supported by the cell in the received bit string. In other of these embodiments, when the result of the first logical AND operation is TRUE, i.e. when none of the features not supported by the WD is indicated as supported by the cell in the received bit string, the WD is configured to determine that the WD is barred from the cell when a result of a second logical AND operation between results of comparisons of bits representing features that the WD supports to bits associated with corresponding features in the received bit string is FALSE, i.e. when at least one feature supported by the WD is not indicated as supported by the cell in the received bit string. In yet another of these embodiments, when a result of the first logical AND operation is TRUE, i.e. when none of the features not supported by the WD is indicated as supported by the cell in the received bit string, the WD is configured to determine that the WD is barred from the cell when a result of a logical OR operation between results of comparisons of bits representing features that the WD supports to bits associated with corresponding features in the received bit string is FALSE, i.e. when no feature supported by the WD is indicated as supported by the cell in the received bit string. In some embodiments, the WD is configured to receive multiple bit strings and perform a comparison of each received bit string with at least one of bits representing features that the WD supports and bits representing features that the WD 22 does not support, each one of the multiple received bit strings representing a different set of features.

FIG. 10 is a flowchart of an example process in a network node 16 for handling cell barring for multiple features. One or more blocks described herein may be performed by one or more elements of network node 16 such as by one or more of processing circuitry 68 (including the access indication unit 32), processor 70, radio interface 62 and/or communication interface 60. Network node 16 is configured to determine a set of indications, each indication being associated with a respective feature relevant for determining whether the WD 22 is allowed to access or camp on a cell 18 served by the network node 16, each indication indicating whether or not the respective feature is supported in the cell 18 (Block S146). The process includes transmitting the set of indications to the WD 22 (Block S148). Having described the general process flow of arrangements of the disclosure and having provided examples of hardware and software arrangements for implementing the processes and functions of the disclosure, the sections below provide details and examples of arrangements for handling cell barring for multiple features. In some embodiments, the set of indications may be a bit string and each indication may be a bit in the bit string. In other embodiments, the set of indications may be a set of fields and each indication may be a field in the set of fields.

In some embodiments, a bit string may be used to bar WDs 22 from accessing and/or camp on a cell. However, using a bitstring is just one example. Some embodiments provide a set of indications, each indication associated with one feature or condition for the WD 22 to be allowed to access or camp on the cell. In some embodiments, the set of indications may be transmitted by the network node 16 and received by the WD 22 in a single message or transmission such as the MIB.

In some embodiments, the WD 22 may be configured to receive multiple sets of indications and the sets of indications may be associated with respective sets of features, which may be different from each other. For each said set of indications, the WD may be configured to compare features of respective subsets of features supported, or not supported, by the WD to features of the respective set of features associated with the set of indications. In some embodiments, a method in the WD 22 includes retrieving information on whether it should consider a cell as barred. The method information may include one or more of the following solutions:

### Solution 1

A bit string, with each bit corresponding to the support of a certain feature, where the WD 22 derives cell barring information based on the bit which corresponds to the feature the WD 22 supports:
a. One bit may indicate the first release of a Radio Access Technology (RAT), while other bits may be used for particular features (specified in the first release of a RAT or on a later release) that require a different handling when accessing the cell. For example, the feature might not be used in the first release of the RAT and the reference signals the WD 22 expects to receive upon initial access may be changed;
b. A possible realization in ASN.1 of this alternative is as follows (with main aspects/changes highlighted in bold):

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | BIT STRING (SIZE (6)), |
| intraFreqReselection | ENUMERATED {allowed, notAllowed}, |
| spare | BIT STRING (SIZE (1)) |

}
-- TAG-MIB-STOP
-- ASN1STOP

MIB field descriptions

```
  cellBarred
  Contains the information on whether a cell is barred for a WD
supporting features corresponding to the indicated bits. First bit
corresponds to support of basic cell access procedure. The second bit
corresponds to feature X, third bit corresponds to feature Y, and so on.
A bit set to 0 indicates that the cell is barred for a WD supporting the
corresponding feature, a bit set to 1 indicates that the cell
is not barred for a WD supporting the corresponding feature.
```

At an initial stage of a release, it may be that only the basic cell access procedure is needed, and thus the other bits may be reserved. A possible implementation of this field is described as follows:

MIB field descriptions

```
  cellBarred
  Contains the information on whether a cell is barred for a WD supporting
features corresponding to the indicated bits. First bit corresponds to support of
basic cell access procedure. In this release of the specification, only the first bit
may be set to 1, the other values are reserved. A bit set to 0 indicates that the cell is
barred for a WD supporting the corresponding feature, a bit set to 1 indicates that
the cell is not barred for a WD supporting the corresponding feature.
```

### Solution 2

A bit string, with each bit corresponding to the support of a certain feature, where the derivation of cell barring information is retrieved based on a combination of bits:
a. In solution 1) above, it is implied that the features defined are mutually exclusive. That means that a WD 22 supporting e.g., feature X, corresponding to the first bit in the bit string, will not simultaneously support feature Y, corresponding to the second bit in the bit string. But there may also be cases where the features are not mutually exclusive. For example, it may be that the cell access procedure defined in the first release of a RAT should be supported by all WDs 22, which may also support another optional feature which may impact cell access. Hence, alternative rules may be defined for a case when the WD 22 supports more than one of the features indicated by the bit string;
b. Assuming that the WD 22 may obtain the cell barring information only from the bits associated with the features it supports, the following solutions may be distinguished:
   i. The WD 22 performs an “or” operation on the relevant bits. This means that the WD concludes that the cell is not barred when at least one of the bits indicate the cell is not barred for a feature that the WD 22 supports. The WD 22 considers the cell to be barred when all bits indicate the cell is barred for each feature that the WD 22 supports;
   ii. The WD 22 performs an “and” operation on the relevant bits. This means that the WD 22 concludes that the cell is barred when at least one of the bits indicate the cell is barred for a feature that the WD 22 supports. The WD 22 considers the cell not to be barred when all bits indicate the cell is not barred for each feature that the WD 22 supports;
c. Assuming that the WD 22 needs to consider all bits (i.e., bits associated with the features it supports and does not support) in order to obtain the cell barring information, the following solutions may be distinguished:

### Steps of Solution 1

The first solution includes the following steps:
1. In the first step, the WD 22 performs an “and” operation on the bits associated with the features it does not support. If the outcome of the “and” operation is 0, the WD 22 concludes that the cell is barred because the cell uses a feature that the WD cannot support. Otherwise, if the outcome of the “and” operation is 1, the WD 22 concludes that the cell does not use a feature that the WD 22 cannot support, and the WD 22 proceeds to the second step;
2. In the second step, the WD 22 checks the bits associated with the features it supports and it does so by performing an “and” operation on the bits associated with the features it supports. If the outcome of the “and” operation is 0, the WD 22 concludes that the cell is barred because the cell is barred for at least one feature that the WD 22 supports. Otherwise, if the outcome of the “and” operation is 1, the WD 22 concludes that the cell is not barred;

### Steps of Solution 2

The second solution includes the following steps:
1. In the first step, the WD 22 performs an “and” operation on the bits associated with the features it does not support. If the outcome of the “and” operation is 0, the WD 22 concludes that the cell is barred because the cell uses a feature that the WD 22 cannot support. Otherwise, if the outcome of the “and” operation is 1, the WD 22 concludes that the cell does not use a feature that the WD 22 cannot support, and the WD 22 proceeds to the second step;
2. In the second step, the WD 22 checks the bits associated with the features it supports and it does so by performing an “or” operation on the bits associated with the features it supports. If the outcome of the “or” operation is 0, the WD 22 concludes that the cell is barred because the cell is barred for at least one feature that the WD 22 supports. Otherwise, if the outcome of the “or” operation is 1, the WD 22 concludes that the cell is not barred;
d. In another alternative, the cell barring information may be retrieved considering a group of features, and/or depending on whether certain features are supported, e.g., if the WD 22 supports feature X and Y but not Z, then the WD 22 should consider the cell as barred if the bits for features X, Y and Z are set to 1 in MIB. If the WD 22 supports feature Z and X, it should consider the cell as not barred if the bits for features X and Z are set to 1 in MIB, regardless of how other values are set;
e. A possible realization in ASN.1 of this alternative is as follows (solution 1 is highlighted in bold) while additional aspects particular for this solution are highlighted in italics):

| | |
|---|---|
| -- ASN1START | |
| -- TAG-MIB-START | |
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | BIT STRING (SIZE (6)), |
| intraFreqReselection | ENUMERATED {allowed, notAllowed}, |
| spare | BIT STRING (SIZE (1)) |
| } | |
| -- TAG-MIB-STOP | |
| -- ASN1STOP | |

MIB field descriptions

```
  cellBarred
  Contains the information on whether a cell is barred for a WD supporting
features corresponding to the indicated bits. First bit corresponds to support of
basic cell access procedure. The second bit corresponds to feature X, third bit
corresponds to feature Y, and so on. The WD considers the cell as not barred if at
least one bit that corresponds to a WD supported feature is set to 1. The WD considers
the cell as barred if all bits that correspond to the WD supported features are set to 0.
```

At an initial stage of a release, it may be that only the basic cell access procedure is needed, and thus the other bits may be reserved. A possible implementation of this in field description is as follows:

MIB field descriptions

```
  cellBarred
  Contains the information on whether a cell is barred for a WD supporting
features corresponding to the indicated bits. First bit corresponds to support of
basic cell access procedure. In this release of the specification, only the first bit
may be set to 1, the other values are reserved. The WD considers the cell as not
barred if at least one bit that corresponds to a WD supported feature is set to 1. The
WD considers the cell as barred if all bits that correspond to the WD supported features
are set to 0.
```

### Solution 3

Solution 1) or 2) above, where multiple fields are used instead of a bit string. That is, each bit in the bit string may correspond to a separate field added to the MIB with values barred and not barred, for example.

### Multiple Sets of the Indications (e.g., Multiple Bit Strings)

The examples above include descriptions of how a set of indications, e.g., bits in a bit string, may be used to bar WDs 22 from accessing or camping on a cell. It may be so that at a first point in time the number of indications is determined to be X. But at a later point in time it may be needed to have more indications than the first set of indications allows for. Consider for example, in case of the approach with a bit string, that the bit string has 8 bits. Later, more than 8 bits may be needed.

To allow, 8 bits, for example, a second set of indications may be introduced. The WD 22 may be required to consider both the first and second set of indications to determine if the cell is barred for the WD 22. In some embodiments, the WD 22 may consider both these sets of indications by concatenating the two sets of indications, e.g., in case bit strings, to concatenate the first and second bit string.

The second set of indications may be conditionally present or provided to the WD 22. Whether the second set of indications is present or provided may be indicated to the WD 22 by the network node 16. One approach to indicate this is that one indication in the first set of indications (e.g., the most (or least) significant bit in the bit string comprising the first set of indications) may be set to a certain value to indicate presence of the second set of indication. Consider for example, at first a bit string of 8 bits. These bits may be assigned to different features or conditions, except the 8th bit. The 8th bit will be set to a first value (e.g., 1) to indicate that there is another bit string sent to the WD 22. A WD 22 which does not support the extension will, as described above, see that the 8th bit is set such that the WD 22 is not allowed to connect to or camp on the cell and hence will be barred. A WD which supports the extension reads the extension and considers both the first 7 bits of the first 8 bits (since the 8th bit itself is used for the purpose of extending the bit string) and the additional bits in the second bit string. The WD 22 may be configured to only connect to or camp on the cell if the WD 22 supports the features associated with the bits that are set in both the first set and the second set.

Thus, there may be multiple sets of the indications. In one embodiment, the first set of the indications are sent in a first message or structure, e.g., in an MIB, and a second set of indications are sent in a second message or structure, e.g., in an SIB.

Some embodiments may include one or more of the following:

Embodiment A1. A network node configured to communicate with a wireless device (WD), the network node configured to, and/or comprising a radio interface and/or comprising processing circuitry configured to:
determine whether the WD is to be barred from access to a cell of the network node for each of a plurality of cell-supported features, the determination being based at least in part on a comparison of WD-supported features with the cell-supported features; and transmit a set of indications to the WD, the set of indications indicating whether the WD is to be barred from access to the cell for each of the cell-supported features.

Embodiment A2. The network node of Embodiment A1, wherein determining whether the WD is to be barred from access to the cell for each cell-supported feature includes performing an OR operation of a bit string of the set of indications with a bit string of the WD-supported features.

Embodiment A3. The network node Embodiment A1, wherein determining whether the WD is to be barred from access to the cell for each feature includes performing an AND operation of a bit string of the set of indications with a bit string of the WD-supported features.

Embodiment B1. A method implemented in a network node, the method comprising:
determining whether the WD is to be barred from access to a cell of the network node for each of a plurality of cell-supported features, the determination being based at least in part on a comparison of WD-supported features with the cell-supported features; and
transmitting a set of indications to the WD, the set of indications indicating whether the WD is to be barred from access to the cell for each of the cell-supported features.

Embodiment B2. The method of Embodiment B1, wherein determining whether the WD is to be barred from access to the cell for each feature includes performing an OR operation of a bit string of the set of indications with a bit string of the WD-supported features.

Embodiment B3. The method of Embodiment B1, wherein determining whether the WD is to be barred from access to the cell for each feature includes performing an AND operation of a bit string of the set of indications with a bit string of the WD-supported features.

Embodiment C1. A wireless device (WD) configured to communicate with a network node, the WD configured to, and/or comprising a radio interface and/or processing circuitry configured to:
receive a set of indications indicating whether the WD is barred from access to a cell of the network node for each of a plurality of cell-supported features; and
determine whether the WD is barred from access to the cell for each cell-supported feature based at least in part on the set of indications and on WD-supported features of the cell-supported features.

Embodiment C2. The WD of Embodiment C1, wherein determining whether the WD is barred from access to the cell for each cell-supported feature includes performing an OR operation of a bit string of the set of indications with a bit string of the WD-supported features.

Embodiment C3. The WD of Embodiment C2, wherein, when at least one bit of the set of indications indicates that the WD is not barred from access to the cell for a WD-supported feature, the WD concludes that access to the cell is not barred for the feature.

Embodiment C4. The WD of any of Embodiments C2 and C3, wherein, when all bits of the set of indications indicate that the WD is barred for each WD-supported feature, the WD concludes that access to the cell is barred for each WD-supported feature.

Embodiment C5. The WD of any of Embodiments C1, wherein determining whether the WD is barred from access to the cell for each cell-supported feature includes performing an AND operation of a bit string of the set of indications with a bit string of the WD-supported features.

Embodiment C6. The WD of Embodiment C5, wherein, when at least one bit of the set of indications indicates that the WD is barred from access to the cell for each WD-supported feature, the WD concludes that access to the cell is barred for the feature.

Embodiment C7. The WD of any of Embodiments C5 and C6, wherein, when all bits of the set of indications indicate that the WD is not barred for each WD-supported feature, the WD concludes that access to the cell is not barred for each WD-supported feature.

Embodiment C8. The WD of Embodiment C1, wherein determining whether the WD is barred from access to the cell for a feature, the WD, radio interface and/or processing circuitry are configured to:
perform a first AND operation on bits associated with features that are not WD-supported to determine when access to the cell is barred because the cell uses a feature that is not WD-supported; and
when performing the first AND operation indicates that the cell does not use a feature that is not WD-supported, perform a second AND operation on bits associated with features that are WD-supported to determine when access to the cell is barred for a feature that is WD-supported.

Embodiment C9. The WD of Embodiment C1, wherein determining whether the WD is barred from access to the cell for a feature, the WD, radio interface and/or processing circuitry are configured to:
perform an AND operation on bits associated with features that are not WD-supported to determine when access to the cell is barred because the cell uses a feature that is not WD-supported; and
when performing the AND operation indicates that the cell does not use a feature that is not WD-supported, perform an OR operation on bits associated with features that are WD-supported to determine when access to the cell is barred for a feature that is WD-supported.

Embodiment D1. A method implemented in a wireless device (WD) configured to communicate with a network node, the method comprising:
receiving a set of indications indicating whether the WD is barred from access to a cell of the network node for each of a plurality of cell supported features; and
determining whether the WD is barred from access to the cell for each cell-supported feature based at least in part on the set of indications and on WD-supported features of the cell-supported features.

Embodiment D2. The method of Embodiment D1, wherein determining whether the WD is barred from access to the cell for each cell-supported feature includes performing an OR operation of a bit string of the set of indications with a bit string of the WD-supported features.

Embodiment D3. The method of Embodiment D2, further comprising, when at least one bit of the set of indications indicates that the WD is not barred from access to the cell for a WD-supported feature, concluding that access to the cell is not barred for the feature.

Embodiment D4. The method of any of Embodiments D2 and D3, further comprising, when all bits of the set of indications indicate that the WD is barred for each WD-supported feature, concluding that access to the cell is barred for each WD-supported feature.

Embodiment D5. The method of any of Embodiments D1, wherein determining whether the WD is barred from access to the cell for each cell-supported feature includes performing an AND operation of a bit string of the set of indications with a bit string of the WD-supported features.

Embodiment D6. The method of Embodiment D5, further comprising, when at least one bit of the set of indications indicates that the WD is barred from access to the cell for a feature that the WD supports, concluding that access to the cell is barred for the feature.

Embodiment D7. The method of any of Embodiments D5 and D6, further comprising, when all bits of the set of indications indicate that the WD is not barred for each WD-supported feature, concluding that access to the cell is not barred for each WD-supported feature.

Embodiment D8. The method of Embodiment D1, wherein determining whether the WD is barred from access to the cell for a feature, includes
performing a first AND operation on bits associated with features that are not WD-supported to determine when access to the cell is barred because the cell uses a feature that is not WD-supported; and
when performing the first AND operation indicates that the cell does not use a feature that is not WD-supported, performing a second AND operation on bits associated with features that are WD-supported to determine when access to the cell is barred for a feature that is WD-supported.

Embodiment D9. The method of Embodiment D1, wherein determining whether the WD is barred from access to the cell for a feature, includes:
performing an AND operation on bits associated with features that are not WD-supported to determine when access to the cell is barred because the cell uses a feature that is not WD-supported; and
when performing the AND operation indicates that the cell does not use a feature that is not WD-supported, performing an OR operation on bits associated with features that are WD-supported to determine when access to the cell is barred for a feature that is WD-supported.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in
the preceding description include:

| | |
|---|---|
| ACK | Acknowledgement |
| AMF | Access and Mobility management Function |
| AS | Access Stratum |
| AN | Access network |
| CE | Control Element |
| CMAS | Commercial Mobile Alert System |
| CN | Core Network |
| CSS | Cross Slot Scheduling |
| DMRS | Demodulation Reference Signal |
| DN | Data Network |
| DRB | Data Radio Bearer |
| DL | Downlink |
| ETWS | Earthquake and Tsunami Warning System |
| eNB | Base station in LTE |
| gNB | Base station in NR |
| HARQ | Hybrid Automatic Request |
| IAB | Integrated Access and Backhaul |
| IP | Internet Protocol |
| L2 | Layer 2 |
| L3 | Layer 3 |
| LTE | Long Term Evolution |
| MAC | Medium Access Control |
| MIB | Master Information Block |
| MM | Mobility Management |
| NACK | Negative ACK |
| NR | New Radio |
| NTN | Non-Terrestrial Network |
| NAS | Non-Access Stratum |
| ProSe | Proximity-based Services |
| PO | Paging Occasion |
| PF | Paging Frame |
| PDU | Packet Data Unit |
| PDSCH | Physical Downlink Shared Channel |
| PDCCH | Physical Downlink Control Channel |
| PDCP | Packet Data Convergence Protocol |
| PSS | Primary Synchronization Signal |
| RAN | Radio Access Network |
| RLC | Radio Link Control |
| RNTI | Radio Network Temporary Identifier |
| RRC | Radio Resource Control |
| RSRP | Reference Signal Received Power |
| RSRQ | Reference Signal Received Quality |
| RB | Radio Bearer |
| SM | Session Management |
| SRB | Signaling Radio Bearer |
| SIB | System Information Block |
| SSS | Secondary Synchronization Signal |
| TAI | Tracking Area Identity |
| TB | Transport Block |
| TR | Technical Report |
| UCI | Uplink Control Information |
| UE | User Equipment (Wireless device in 3GPP systems) |
| UL | Uplink |
| WG | Working Group |

It will be appreciated by persons skilled in the art that the present invention is not limited to what has been particularly shown and described herein above. In addition, unless mention was made above to the contrary, it may be noted that all of the accompanying drawings are not to scale. A variety of modifications and variations are possible in light of the above teachings without departing from the scope of the following claims.

1. A wireless device, WD, configured to communicate with a network node, the WD configured to:
receive a set of indications from the network node, each indication being associated with a respective feature relevant for determining whether the WD is allowed to access or camp on a cell served by the network node, each indication indicating whether or not said respective feature is supported in the cell; and
determine whether the WD is barred from the cell based at least in part on whether the WD supports a feature indicated by an indication in the set of indications as supported in the cell.

2. The WD of claim 1, wherein the WD being configured to determine whether the WD is barred from the cell includes the WD being configured to compare features supported by the WD to features indicated by the set of indications to be supported in the cell.

3. The WD of claim 1, wherein the set of indications is one of:
a bit string, each bit being associated with a respective feature relevant for determining whether or not the WD is allowed to access or camp on a cell served by the network node; and
a set of fields, each field being associated with a respective feature relevant for determining whether or not the WD is allowed to access or camp on a cell served by the network node.

4. The WD of claim 1, wherein the WD being configured to determine whether the WD is barred from the cell includes the WD being configured to determine, for features supported by the WD, whether or not the indications associated with corresponding features in the set of indications indicate that these features are supported in the cell and determine that the WD is barred from the cell when a result of the determination for the features supported by the WD is that the WD is barred for each of the features that the WD supports.

5. The WD of claim 1, wherein the WD being configured to determine whether the WD is barred from the cell includes the WD being configured to determine, for features supported by the WD, whether or not the indications associated with corresponding features in the set of indications indicate that these features are supported in the cell and determine that the WD is barred from the cell when a result of the determination for the features supported by the WD is that the WD is barred for at least one of the features that the WD supports.

6. The WD of claim 1, wherein the WD being configured to determine whether the WD is barred from the cell includes the WD being configured to determine whether the WD is barred from the cell for a subset of the features that the WD supports.

7. The WD of claim 1, wherein the WD being configured to determine whether the WD is barred from the cell includes the WD being configured to determine, for features that the WD does not support, whether or not the indications associated with corresponding features in the set of indications indicate that these features are supported in the cell.

8. The WD of claim 7, wherein the WD is further configured to determine that the WD is barred from the cell when a result of the determination for features that the WD does not support is that the WD is barred for at least one of the features that the WD does not support.

9. The WD of claim 7, wherein, when a result of the determination for features that the WD does not support is that the WD is not barred for any of said features that the WD does not support, the WD is further configured to determine, for features supported by the WD, whether or not the indications associated with corresponding features in said set of indications indicate that these features are supported in the cell and determine that the WD is barred from the cell when a result of the determination for the features supported by the WD is that the WD is barred for at least one of the features that the WD supports.

10. The WD of claim 7, wherein, when a result of the determination for features that the WD does not support is that the WD is not barred for any of the features that the WD does not support, the WD is further configured to determine, for features supported by the WD, whether or not the indications associated with corresponding features in the set of indications indicate that these features are supported in the cell and determine that the WD is barred from the cell when a result of the determination for the features supported by the WD is that the WD is barred for each of the features that the WD supports.

11. The WD of claim 1, wherein the set of indications is a bit string and wherein each indication is a bit in the bit string OR wherein the set of indications is a set of fields and wherein each indication is a field in the set of fields.

12. A method performed by a wireless device, WD, for communicating with a network node, the method comprising:
receiving a set of indications from the network node, each indication being associated with a respective feature relevant for determining whether the WD is allowed to access or camp on a cell served by the network node, each indication indicating whether or not said respective feature is supported in the cell; and
determining whether the WD is barred from the cell based at least in part on whether the WD supports a feature indicated by an indication in the set of indications as supported in the cell.

13. (canceled)

14. (canceled)

15. The method of claim 12, wherein determining whether the WD is barred from the cell includes determining, for features supported by the WD, whether or not the indications associated with corresponding features in the set of indications indicate that these features are supported in the cell and determining that the WD is barred from the cell when a result of the determination for the features supported by the WD is that the WD is barred for each of the features that the WD supports.

16. The method of claim 12, wherein determining whether the WD is barred from the cell includes determining, for features supported by the WD, whether or not the indications associated with corresponding features in the set of indications indicate that these features are supported in the cell and determining that the WD is barred from the cell when a result of the determination for the features supported by the WD is that the WD is barred for at least one of the features that the WD supports.

17. (canceled)

18. The method of claim 12, wherein determining whether the WD is barred from the cell includes determining, for features that the WD does not support, whether or not the indications associated with corresponding features in the set of indications indicate that these features are supported in the cell.

19. The method of claim 18, further comprising determining that the WD is barred from the cell when a result of the determination for features that the WD does not support is that the WD is barred for at least one of the features that the WD does not support.

20. The method of claim 18, further comprising, when a result of the determination for features that the WD does not support is that the WD is not barred for any of said features that the WD does not support, determining, for features supported by the WD, whether or not the indications associated with corresponding features in said set of indications indicate that these features are supported in the cell and determining that the WD is barred from the cell when a result of the determination for the features supported by the WD is that the WD is barred for at least one of the features that the WD supports.

21. The method of claim 18, further comprising, when a result of the determination for features that the WD does not support is that the WD is not barred for any of the features that the WD does not support, determining, for features supported by the WD, whether or not the indications associated with corresponding features in the set of indications indicate that these features are supported in the cell and determining that the WD is barred from the cell when a result of the determination for the features supported by the WD is that the WD is barred for each of the features that the WD supports.

22. (canceled)

23. A network node configured to communicate with a wireless device, WD, the network node configured to:
determine a set of indications, each indication being associated with a respective feature relevant for determining whether the WD is allowed to access or camp on a cell served by the network node, each indication indicating whether or not the respective feature is supported in the cell; and
transmit the set of indications to the WD.

24. A method performed by a network node for communicating with a wireless device, WD, the method comprising:
determining a set of indications, each indication being associated with a respective feature relevant for determining whether the WD is allowed to access or camp on a cell served by the network node, each indication indicating whether or not the respective feature is supported in the cell; and
transmitting the set of indications to the WD.
